(19) United States
(12) Patent Application Publication
(10) Pub. No.: US 2025/0386297 A1
(43) Pub. Date: Dec. 18, 2025

(54) Wake-On-Signal Function In Frequency-Modulation Based Communication Systems

(71) Applicant: Integrated Silicon Solution Israel Ltd., Tel-Aviv (IL)

(72) Inventors: Eitan Tene, Hod-Hasharon (IL); Eyal Pollack, Givatayim (IL); Raphi Zadicario, Tel-Aviv (IL)

(21) Appl. No.: 19/084,762

(22) Filed: Mar. 20, 2025

Related U.S. Application Data
(60) Provisional application No. 63/661,545, filed on Jun. 18, 2024.

(51) Int. Cl. H04W 52/02; H04L 5/00

(52) U.S. Cl. CPC H04W 52/0235; H04L 5/0007

(57) ABSTRACT

A system and method implements a wakeup function in a frequency-modulation based data communication network. In particular, a wakeup function is implemented which transmits a wake up data pattern (Wake On Signal) over the data links between network nodes in a frequency-modulation based data communication system to enable an inactive node to be awaken and transition to an active or operational power mode.

### CROSS REFERENCE TO RELATED APPLICATIONS

This application claims priority to U.S. Provisional Patent Application No. 63/661,545, entitled “Wake-On-Signal Function In Frequency-Modulation Based Communication Systems,” filed Jun. 18, 2024, which is incorporated herein by reference for all purposes.

### FIELD OF THE INVENTION

The invention relates to a data communication network and, in particular, to a system and method for providing a wake-on-signal function in a data communication network implementing a frequency modulation based communication scheme.

### BACKGROUND OF THE INVENTION

A data communication network is a system that enables two or more network nodes to communicate with each other. The network nodes (also referred herein as “nodes”) are connected to a communication medium to exchange data under a predefined communication protocol. The connection between the nodes are sometimes referred to as data links. These data links can be established over cable media such as wires or optic cables, or wireless media such as Wi-Fi. Network nodes can be coupled to various types of electronic equipment or devices depending on the environment in which the data network is established. In a home network environment, the network nodes can be coupled to computers, phones, televisions, Internet-of-Things devices (such as cameras, lights, or sensors). In an automotive environment, a data network can include nodes that communicate with each other in the automobile, such as nodes coupled to sensors, light, temperature control, or engine function controls.

In some power-sensitive systems, the network nodes are required to implement power modes for power saving. For example, nodes in a data communication network may be required to implement an “active” mode and a “non-active” mode. In the “active” power mode, the node is operational and consumes power to enable its operation. In the “non-Active” power mode, the node is either nonoperational or partially operational, such that the power consumption of the node is reduced.

While the decision to go from the “active” mode to the “nonactive” mode can be obtained and executed by the node as the node is active and operational, the indication to go from the “non-active” mode to the “active” mode must be triggered from an external source as the node is not active. The change of operation mode from “non-active” to “active” is referred as “Wakeup” of a node.

Some signal-based communication protocols specify means for a “Wakeup” function so that a node that is in the “active” mode can wake up a node that is in the “non-active” mode. For example, Wake-on-LAN (WoL or WOL) is an Ethernet or Token Ring computer networking standard that allows a computer to be turned on or awakened from sleep mode by a network message that identifies the computer's medium access control (MAC) address. However, in frequency-modulation based communication protocols (for example OFDM), such a wakeup function is not available.

### SUMMARY OF THE INVENTION

The present disclosure discloses a wakeup function in a frequency-modulation based data communication network, substantially as shown in and/or described below, for example in connection with at least one of the figures, as set forth more completely in the claims.

In some embodiments, a network node in a data communication network of two or more network nodes, the two or more network nodes communicating over a communication medium using a frequency-modulation based communication protocol, the network node including a wake up module coupled to the network node. The wake up module includes a low pass filter coupled to receive a signal indicative of an incoming signal on the communication medium, the incoming signal being transmitted using the frequency-modulation based communication protocol, the low pass filter generating a filtered signal indicative of an envelope of the incoming signal; a digitizer coupled to receive the filtered signal and to generate a digital signal having a digital data pattern indicative of the envelope of the incoming signal; and a pattern detector configured to compare the digital data pattern of the digital signal to a predefined wake up data pattern, the pattern detector generating a wake up signal in response to the digital data pattern of the digital signal matching the predefined wake up data pattern, the wake up signal being provided to the associated network node to cause the network node to transition to an active power mode.

In other embodiments, a method in a network node in a data communication network including two or more network nodes communicating over a communication medium using a frequency-modulation based communication protocol includes: at a network node operating in a non-active power mode, receiving an incoming signal from the communication medium; filtering a signal indicative of the incoming signal to extract an envelope of the incoming signal; digitizing the filtered signal to generate a digital signal having a digital data pattern indicative of the envelope of the incoming signal; comparing the digital data pattern of the digital signal to a predefined wake up data pattern; and in response to the digital data pattern of the digital signal matching the predefined wake up data pattern, generating a wake up signal and providing the wake up signal to the associated network node to cause the network node to transition to an active power mode.

These and other advantages, aspects and novel features of the present invention, as well as details of an illustrated embodiment thereof, will be more fully understood from the following description and drawings.

### BRIEF DESCRIPTION OF THE DRAWINGS

Various embodiments of the invention are disclosed in the following detailed description and the accompanying drawings. Although the drawings depict various examples of the invention, the invention is not limited by the depicted examples. It is to be understood that, in the drawings, like reference numerals designate like structural elements. Also, it is understood that the depictions in the figures are not necessarily to scale.

FIG. 1 is schematic diagram illustrating a communication network including devices or nodes implementing the wake-on-signal function in some embodiments of the present invention.

FIG. 2 is a schematic diagram of a wake-on-signal module in some embodiments of the present invention.

FIG. 3 is a flowchart illustrating a method implemented in a network node to wake up from an inactive power mode in a frequency modulation based data communication network in some embodiments.

### DETAILED DESCRIPTION OF THE INVENTION

In embodiments of the present invention, a system and method is provided to implement a wakeup function in a frequency-modulation based data communication network. In particular, the system and method of the present invention implements a wakeup function in which a wake up data pattern (Wake On Signal) is transmitted over the data links between network nodes in a frequency-modulation based data communication system to enable an inactive node to be awaken and transition to an active or operational mode. The wakeup function can be applied in any frequency-modulation based data communication system. In one embodiment, the wakeup function is implemented in an orthogonal frequency-division multiplexing (OFDM) communication system.

In the present description, a network node or a node refer to a transceiver (a transmitter and a receiver) which is coupled to a communication medium of a communication network to transmit and receive signals to and from the communication medium using a defined communication protocol. In a frequency-modulation based data communication system, the network node transmits and receives signals using a frequency-modulation based data communication protocol. The node maybe coupled to a networked device to which the node provides data received on the communication medium or form which the node receives data to be transmitted onto the communication medium. A networked device maybe a computer, a sensor, a light switch or other devices that can be controlled over a network. The networked device processes and/or generates signals to be communicated by the node over the communication medium.

In the present description, orthogonal frequency-division multiplexing (OFDM) refers to a type of digital transmission used in digital modulation for encoding digital (binary) data on multiple carrier frequencies. An OFDM modulation system splits the transmitted signal into multiple orthogonal subcarriers. Data is encoded by modulating the subcarrier using a given modulation scheme. In the present description, an OFDM network node or OFDM node refers to a transceiver that applies the OFDM modulation scheme.

In some embodiments, the wakeup function is implemented in an automotive communication network in which nodes in an automobile communicate using a frequency-modulation based communication system, such as OFDM. It is desirable to set the OFDM nodes to a lower power state, such as a non-active power mode to conserve power. For example, when the automobile is parked, it is desirable the data communication network and the transceivers (nodes) connected thereto be powered down or be in an inactive mode in order not to drain the battery. The wakeup function in embodiments of the present invention provides the means to wake up inactive or nodes over the data communication network as needed.

In other embodiments, the wakeup function can be implemented in other network environments, such as a home network environment, where the nodes communicate using a frequency-modulation based communication system.

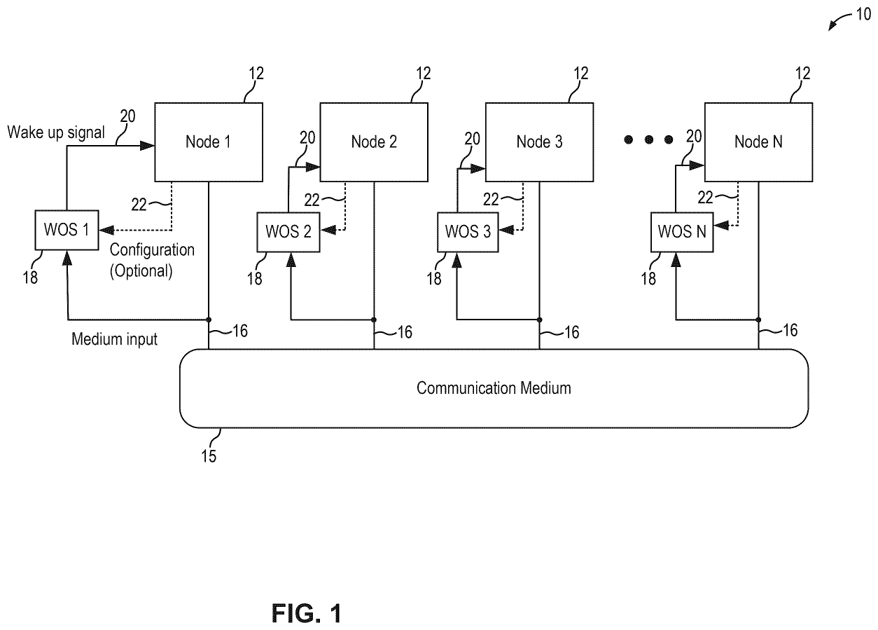

FIG. 1 is schematic diagram illustrating a communication network including devices or nodes implementing the wake-on-signal function in some embodiments of the present invention. Referring to FIG. 1, a data network 10 includes two or more nodes 12 communicating over a communication medium 15 using a frequency-modulation based communication protocol. In the present illustration, Node 1 to Node N are illustrated. In one example, the nodes 12 in the data network 10 receives and transmits frequency modulated signals, such as under the OFDM protocol. Under the OFDM protocol, each node 12 receives and transmits data in the form of OFDM frames. The communication medium 15 can be a wired media such as wires or cables, or wireless media such as Wi-Fi.

In embodiments of the present invention, the nodes 12 are configured to operate two power modes. In particular, each node 12 can be in an “active” mode or in an “non-active” mode. In the “active” mode, the node is operational and consumes power to enable its operation. In the “non-active” mode, the node is either nonoperational or partially operational, such that the power consumption of the node is reduced. A node that is in the active power mode is sometimes referred to as an “active node” and a node that is in the non-active power mode is sometimes referred to as an “inactive node.”

In embodiments of the present invention, each node 12 is configured to transmit a set of OFDM frames that represents a wake up data pattern, also referred to as a Wake On Signal. In one embodiment, the wake up data pattern is a predefined set of signal transmissions and gaps to indicate to a remote node that it should wake up. In particular, the data represented in the signal transmissions is irrelevant to the wakeup function. Instead, the set of signal transmission and gaps between transmissions are used as a means to generate an envelope pattern to represent a wake up indicator. For example, in an OFDM system, the signals carried by the frequency subcarriers are not of interest. Rather, the set of signal transmissions and gaps between the transmissions provides a signal envelope to indicate the wake up data pattern.

In some embodiments, each node 12 (Node 1 to Node N) is coupled to or incorporates a wake-on-signal (WOS) module 18 to implement the wakeup function. The WOS module 18 detects the wake up data pattern sent by a remote “active” node over the communication medium 15 and generates a local wake up signal on an output signal line 20 to wake up the local node. In some embodiments, the local wake up signal is an interrupt signal. For instance, each WOS module 18 (WOS 1 to WOS N) receives input signals from the communication medium 15 via a respective medium input signal line 16. The WOS module 18 detects the wake up data pattern in the input signal on the medium input signal line 16 to determine that a remote active node is instructing the local node to wake up.

In FIG. 1, the WOS module 18 is shown as a circuit block separate from the associated local network node. The configuration shown in FIG. 1 is illustrative only and is not intended to be limiting. In actual implementations, the WOS module 18 can be provided as part of the network node 12. That is, the WOS module and the network node circuitry can be formed as a monolithic component. In other implementations, the WOS module 18 can be provided as a component separate from the circuitry of the network node.

In some examples, in an automobile environment, various nodes are connected to a frequency modulation based communication network, such as an OFDM based network. A sensor on the car's door detects a signal and wakes up the associated node. The sensor-activated node then needs to wake up or activate all the other nodes in the communication network of the automobile, that is to activate all the transceivers connected to the communication medium of the network. The sensor-activated node sends the wakeup data pattern from its transmitter onto the communication medium. The WOS module at each of the other nodes detects the wake up data pattern and generates the local interrupt signal to wake up or activate the local node. In this manner, all the network nodes of the communication network is activated and the automobile's central processing unit can proceed to perform predefined functions.

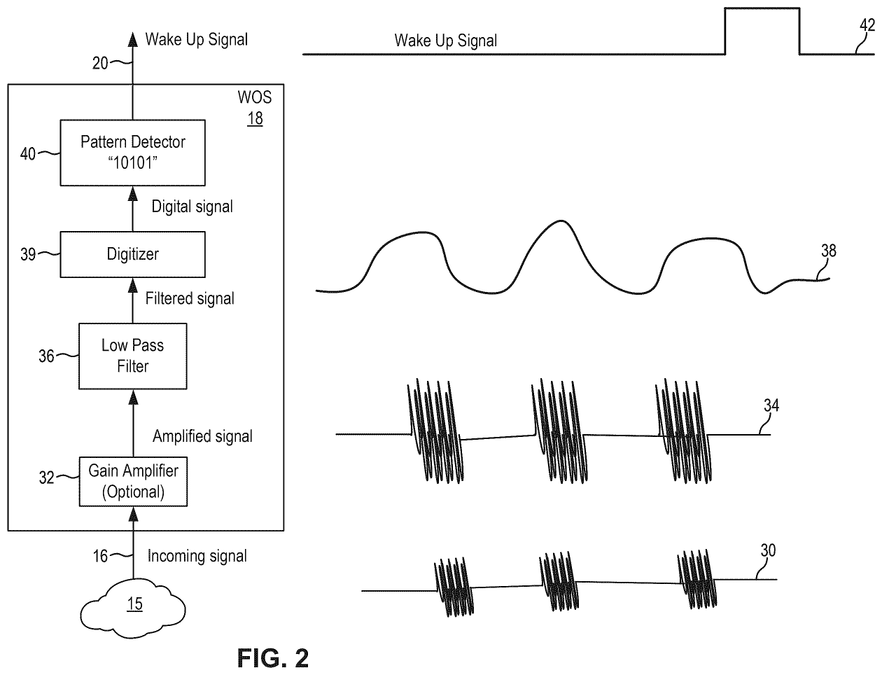

FIG. 2 is a schematic diagram of a wake-on-signal module in some embodiments of the present invention. In FIG. 2, the wake-on-signal module (WOS) is illustrated with the signal waveforms at each stage of the signal processing. The wake-on-signal module of FIG. 2 can be used to implement the WOS module 18 in the data network 10 of FIG. 1. Referring to FIG. 2, a wake-on-signal (WOS) module 18 is coupled to or incorporated in a network node. The WOS module 18 is coupled to the communication medium (e.g. communication medium 15 of FIG. 1) to which the network node is coupled and receives an incoming signal 30 on the medium input signal line 16 from the communication medium 15. The incoming signal 30 is a frequency modulated signal, such as an OFDM modulated signal, which includes signal transmission of modulated subcarriers and gaps between the transmissions.

The WOS module 18 includes an optional gain amplifier 32 to amplify the received incoming signal 30, such as to compensate for medium attenuation. The gain amplifier 32 can be omitted if signal attenuation is insignificant in the data network. When applicable, the incoming signal 30 is amplified or buffered to an amplified signal 34.

The WOS module 18 includes a low pass filter 36 which receives an input signal being either the incoming signal 30 or the amplified signal 34 (depending on whether the optional gain amplifier 32 is included). The low pass filter removes the high frequency components of the input signal 30 or the amplified signal 34. The output signal of the low pass filter 36 is a filtered signal 38 which tracks the envelope of the frequency modulated incoming signal 30. The data content in the incoming signal 30 is irrelevant and is removed by the low pass filter 36. The WOS module 18 operates only on the signal envelope of the incoming signal 30.

The WOS module 18 includes a digitizer 39 and a pattern detector 40 to extract the data pattern represented by the filtered signal 38 and to detect whether the extracted data pattern matches a predefined wake up data pattern. In particular, the filtered signal 38 represents the envelope of the incoming signal 30 received by the WOS module 18. The peaks and valleys of the signal envelope of the filtered signal 38 correspond to signal transmission and gaps between transmissions in the incoming signal 30. In embodiments of the present invention, the digitizer 39 converts the signal envelope of the filtered signal 38 into a digital signal, including a digital data pattern of 1's and 0's. The pattern detector 40 compares the digital data pattern of the digital signal to the predefined wake up data pattern. In the present example, the wake up data pattern is given as “10101”. In the case the extracted digital data pattern of the digital signal matches the wake up data pattern, the WOS module 18 generates a wake up signal 42 on the output signal line 20. The wake up signal 42 on the output signal line 20 is provided to the local node to wake up or activate the node. In some embodiments, the wake up signal 42 is an interrupt signal that is normally deasserted and is asserted for a given duration in response to the detection of the wake up data pattern in the input signal 30. In particular, waking up or activating the node refers to powering up the transceiver of the node to enable the node to receive and transmit data through the communication medium. In this manner, an inactive node can be awakened as a result of the WOS module 18 receiving an incoming signal having the predetermined wake up data pattern.

In the present illustration, the wake up data pattern is given as “10101” which is illustrative only. In other embodiments, other data patterns can be used as the wake up data pattern.

In embodiments of the present invention, a method in a frequency modulation based data communication network to wake up inactive network nodes is described. The data communication network includes at least two network nodes which can be operated in an active power mode (“an active node”) or a non-active power mode (“an inactive node”). In one example, the data communication network implements the OFDM protocol. In some embodiments, an active node in the data communication network transmits a wake up data pattern on the communication medium. For example, an active node in the data communication network is operated to wake up the inactive nodes in the network by transmitting the wake up data pattern onto the communication medium. Each inactive node receives incoming signals on the communication medium and detects for the wake up data pattern. In response to detecting the wake up data pattern in the incoming signal, the inactive node generates a wake up signal transition the network node to the active power mode.

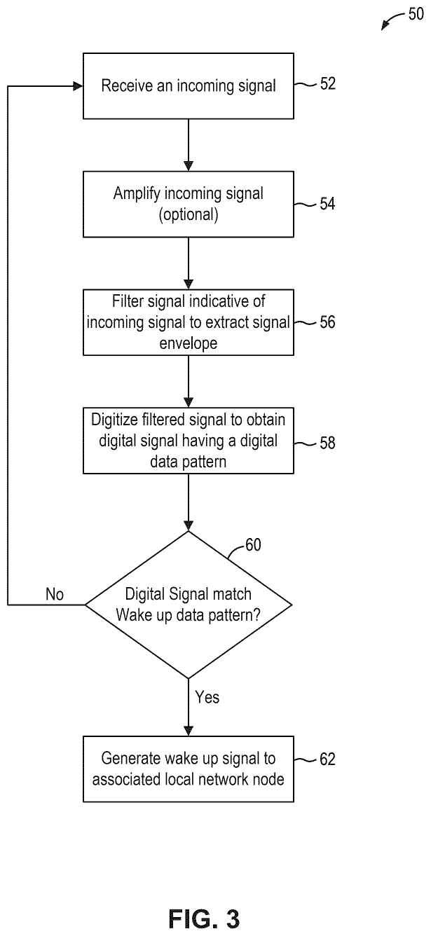

FIG. 3 is a flowchart illustrating a method implemented in a network node to wake up from an inactive power mode in a frequency modulation based data communication network in some embodiments. Referring to FIG. 3, a method 50 is implemented in a network node connected to a communication medium in a frequency modulation based data communication network. At a network node that is in a non-active power mode (an inactive node), the method 50 receives incoming signals from the communication medium (52). In an optional step, the method 50 may amplify the incoming signal (54). The method 50 then filters a signal indicative of the incoming signal to extract the signal envelope of the incoming signal (56). That is, the method 50 may filter the incoming signal if no signal amplification is applied. Alternately, the method 50 may filter the amplified signal of the incoming signal. In some embodiments, the method 50 filters the signal using a low pass filter.

The method 50 then digitizes the filtered signal to obtain a digital signal having a digital data pattern (58). The digital data pattern corresponds to the extracted signal envelope of the incoming signal. The method 50 then compares the detected digital data pattern to a predefined wake up data pattern (60). In the case the detected digital signal pattern matches the predefined wake up data pattern, the method 50 generates a wake up signal to the associated local node (62). The associated local node, in response to the wake up signal, transitions to the active power mode. For instance, the transceiver of the local node is powered on. In some embodiments, the wake up signal is an interrupt signal.

In the case a match is not detected (60), the local node is not awakened. The method 50 continues to receive incoming signal (52) and to detect the wake up data pattern in the incoming signal. In this manner, extraneous transmission on the communication medium will not cause non-active nodes to wake up unnecessarily and power conservation can be realized.

Returning to FIG. 1, in some embodiments, each network node 12 is provided with configuration functions which can be used to configure the WOS module 18 associated therewith, such as to set one or more wake up data patterns. The configuration data can be provided by the network node 12 to the WOS module 18 on a signal line 22.

In one embodiment, a first wake up data pattern can be used in the data network to wake up all the nodes in the network and a second wake up data pattern is used to wake up a specific node in the network. In this manner, an active node can send the appropriate wake up data pattern to wake up one or all of the nodes in the data network. An inactive network node, upon detecting a wake up data pattern, determines if the wake up data pattern is the first wake up data pattern or the second wake up data pattern. In the case the first wake up data pattern is detected, the wake up signal is generated and the inactive network node will transition to the active power mode. In the case the second wake up data pattern is detected, the inactive network node further determines if the second wake up data pattern is associated with or linked to the local network node. In the case the second wake up data pattern is linked to the local network node, the wake up signal is generated and the network node will transition to the active power mode. In the case the second wake up data pattern is not linked to the local network node, the wake up signal is not generated and the network node will remain in the non-active power mode.

In some embodiments, the node can also use the configuration functions to set or adjust the internal gain of the gain amplifier (amplifier 32 in FIG. 2) to enable the detection of the incoming signal even after medium attenuation.

Conventional system may implement wakeup schemes whereby inactive network nodes are periodically awakened to detect incoming signals to determine if the nodes should transition to an active power mode. Periodically waking up the nodes in a network results in undesirable power consumption. To the contrary, the wake up function of the present invention enables nodes in a frequency-modulation based communication system to be put in a non-active mode where the nodes do not wake up until the wake up data pattern is received and detected by the WOS module. No periodic wake up is used and therefore the wake up function of the present invention enables the data communication system to realize improved power conservation, which is especially important in power sensitive applications.

In this detailed description, process steps described for one embodiment may be used in a different embodiment, even if the process steps are not expressly described in the different embodiment. When reference is made herein to a method including two or more defined steps, the defined steps can be carried out in any order or simultaneously, except where the context dictates or specific instruction otherwise are provided herein. Further, unless the context dictates or express instructions otherwise are provided, the method can also include one or more other steps carried out before any of the defined steps, between two of the defined steps, or after all the defined steps.

In this detailed description, various embodiments or examples of the present invention may be implemented in numerous ways, including as a process; an apparatus; a system; and a composition of matter. A detailed description of one or more embodiments of the invention is provided above along with accompanying figures that illustrate the principles of the invention. The invention is described in connection with such embodiments, but the invention is not limited to any embodiment. Numerous modifications and variations within the scope of the present invention are possible. The scope of the invention is limited only by the claims and the invention encompasses numerous alternatives, modifications, and equivalents. Numerous specific details are set forth in the description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured. The present invention is defined by the appended claims.

1. A network node in a data communication network of two or more network nodes, the two or more network nodes communicating over a communication medium using a frequency-modulation based communication protocol, the network node comprising:
a wake up module coupled to the network node, the wake up module comprising:
a low pass filter coupled to receive a signal indicative of an incoming signal on the communication medium, the incoming signal being transmitted using the frequency-modulation based communication protocol, the low pass filter generating a filtered signal indicative of an envelope of the incoming signal;
a digitizer coupled to receive the filtered signal and to generate a digital signal having a digital data pattern indicative of the envelope of the incoming signal; and
a pattern detector configured to compare the digital data pattern of the digital signal to a predefined wake up data pattern, the pattern detector generating a wake up signal in response to the digital data pattern of the digital signal matching the predefined wake up data pattern, the wake up signal being provided to the associated network node to cause the network node to transition to an active power mode.

2. The network node of claim 1, wherein the wake up module is incorporated in the network node to form a monolithic component.

3. The network node of claim 1, wherein the wake up module is implemented in a component separate from the network node.

4. The network node of claim 1, wherein the network node comprises a transceiver to transmit and receive signals to and from the communication medium using the frequency-modulation based communication protocol.

5. The network node of claim 1, wherein the frequency-modulation based communication protocol comprises an orthogonal frequency-division multiplexing (OFDM) communication protocol.

6. The network node of claim 1, wherein the wake up signal comprises an interrupt signal.

7. The network node of claim 1, wherein the wake up module further comprises an amplifier to amplify the incoming signal and providing the amplified signal to the low pass filter.

8. The network node of claim 1, wherein the predefined wake up data pattern comprises a first wake up data pattern and a second wake up data pattern, the first wake up data pattern causing all network nodes in the data communication network to transition to the active power mode and the second wake up data pattern causing a subset of the network nodes in the data communication network to transition to the active power mode.

9. The network node of claim 8, wherein the pattern detector determines whether the digital data pattern of the digital signal matches the first wake up data pattern; and in response to the digital data pattern of the digital signal matching the first wake up data pattern, the pattern detector generates the wake up signal.

10. The network node of claim 8, wherein the pattern detector determines whether the digital data pattern of the digital signal matches the second wake up data pattern; and in response to the digital data pattern of the digital signal matching the second wake up data pattern, the pattern detector further determines whether the second wake up data pattern is linked to the associated network node; and in response to the second wake up data pattern being linked to the associated network node, the pattern detector generates the wake up signal; and in response to the second wake up data pattern being not linked to the associated network node, the pattern detector does not generate the wake up signal.

11. The network node of claim 1, wherein the incoming signal comprises a set of signal transmissions and gaps between the signal transmissions.

12. A method in a network node in a data communication network including two or more network nodes communicating over a communication medium using a frequency-modulation based communication protocol, the method comprising:
at a network node operating in a non-active power mode, receiving an incoming signal from the communication medium;
filtering a signal indicative of the incoming signal to extract an envelope of the incoming signal;
digitizing the filtered signal to generate a digital signal having a digital data pattern indicative of the envelope of the incoming signal;
comparing the digital data pattern of the digital signal to a predefined wake up data pattern; and
in response to the digital data pattern of the digital signal matching the predefined wake up data pattern, generating a wake up signal and providing the wake up signal to the associated network node to cause the network node to transition to an active power mode.

13. The method of claim 12, further comprising:
amplifying the incoming signal and providing the amplified signal as the signal indicative of the incoming signal for filtering.

14. The method of claim 12, wherein the frequency-modulation based communication protocol comprises an orthogonal frequency-division multiplexing (OFDM) communication protocol.

15. The method of claim 12, wherein generating the wake up signal comprises generating an interrupt signal.

16. The method of claim 12, wherein filtering the signal indicative of the incoming signal comprises low-pass filtering the signal.

17. The method of claim 12, wherein the incoming signal comprises a set of signal transmissions and gaps between transmissions.

18. The method of claim 12, wherein the predefined wake up data pattern comprises a first wake up data pattern and a second wake up data pattern, the first wake up data pattern causing all network nodes in the data communication network to transition to the active power mode and the second wake up data pattern causing a subset of the network nodes in the data communication network to transition to the active power mode.

19. The method of claim 18, further comprising:
in response to the digital data pattern of the digital signal matching the first wake up data pattern, generating the wake up signal and providing the wake up signal to the associated network node to cause the network node to transition to an active power mode.

20. The method of claim 18, further comprising:
in response to the digital data pattern of the digital signal matching the second wake up data pattern, determining whether the second wake up data pattern is linked to the associated network node;
in response to the second wake up data pattern being linked to the associated network node, generating the wake up signal and providing the wake up signal to the associated network node to cause the network node to transition to an active power mode; and
in response to the second wake up data pattern being not linked to the associated network node, not generating the wake up signal.
